(19) United States
(12) Patent Application Publication
(10) Pub. No.: US 2008/0238589 A1
(43) Pub. Date: Oct. 2, 2008

(54) Air cap design for controlling spray flux

(76) Inventors: Nhan Toan Quan, Chandler, AZ (US); Harikrishnan Ramanan, Chandler, AZ (US)

Correspondence Address: CAVEN & AGHEVLI;c/o INTELLEVATE, LLC, P.O. BOX 52050, MINNEAPOLIS, MN, 55402, US

(21) Appl. No.: 11/729,486

(22) Filed: Mar. 29, 2007

(51) Int. Cl. H01H 51/22

(52) U.S. Cl. 335/85

(57) ABSTRACT

Methods and apparatus to improve air cap design for controlling spray flux are described. In one embodiment, a plurality of opposing gas inlets are provided in an air cap, e.g., to reduce or eliminate potential opposing turbulence inside the air cap. Other embodiments are also described.

### BACKGROUND

The present disclosure generally relates to the field of electronics. More particularly, an embodiment of the invention generally relates to improving air cap design for controlling spray flux.

Flux may be utilized during the manufacturing process of electronic devices, e.g., to assist during soldering of integrated circuits. In some implementations, flux may be sprayed over a substrate. However, flux overspray or spray splash may result in critical issues such as spray paste related rework or touch-up. Addressing these issues may be time consuming and may further add to the costs associated with manufacturing an electronic device.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a view of flux spray flow in accordance with an embodiment of the invention.

FIG. 2 illustrates a block diagram of a flux spray system, according to an embodiment.

FIG. 3 illustrates a top view of a flux spray system in accordance with an embodiment of the invention.

FIG. 4 illustrates a block diagram of a method according to an embodiment.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic”shall mean either hardware, software, or some combination thereof.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

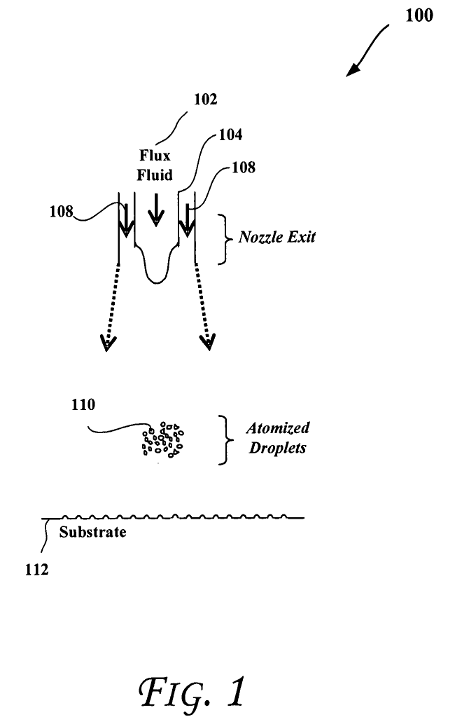

Some of the embodiments discussed herein (such as the embodiments discussed with reference to FIGS. 1-4) may utilize techniques to improve flux spray and/or splash control. More particularly, FIG. 1 illustrates a side view of a flux spray flow pattern development configuration, in accordance with an embodiment of the invention. As shown in FIG. 1, flux fluid 102 may be dispensed from a flux tube 104 (e.g., with assistance from a coaxial assist fluid 108 in an embodiment) through a sequential atomization process that may break the initial droplets (e.g., at the exit of the flux tube 104) into smaller atomized droplets 110 which subsequently are deposited on a substrate 112. In an embodiment, the coaxial assist fluid 108 may be dispensed around the circumference of the flux tube 104. In some embodiments, the flux fluid 102 may include various materials that would be classified as soldering fluxes in semiconductor packaging technology. The flux tube 104 may be constructed with various types of material capable of transporting the flux fluid 102 such as metal or metal alloy, plastic or polymer, ceramic, etc. Moreover, the substrate 112 may be any type of a substrate such as a printed circuit board (PCB), organic or ceramic packages, and may include solder bumps to allow for connection of dies to the substrate 112.

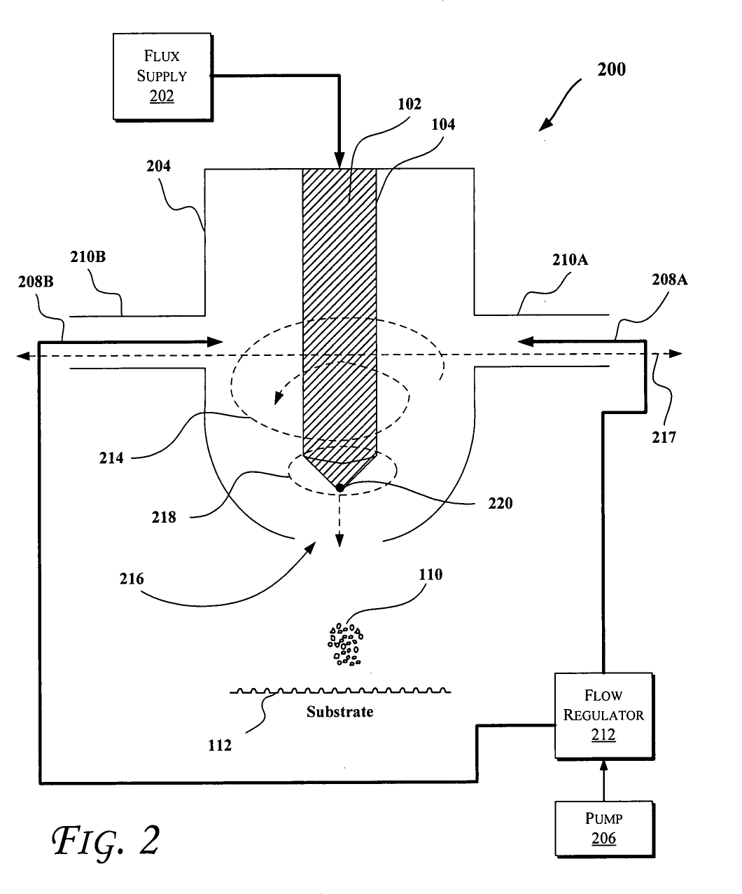

FIG. 2 illustrates a block diagram of a flux spray system 200, according to an embodiment. The system 200 may deliver the flux fluid 102 through the flux tube 104 as the atomized droplets 110 that are deposited on the substrate 112, such as discussed with reference to FIG. 1. As shown in FIG. 2, the system 200 may include a flux supply 202 to supply the flux fluid 102. The flux tube 104 may be provided inside an air cap 204. The air cap 204 may be coupled to an air pump 206 to receive a flow of a gas (208A and 208B), including an inert gas, such as air, nitrogen, mixtures thereof, etc., through inlets 210A and 210B. In an embodiment, a flow regulator 212 (such as an inline flow regulator) may be coupled between the pump 206 and the inlet 210 to regulate the flow of gases into the air cap 204. In some embodiments, the flows 208A and 208B may have an equal flow rate, whereas in other embodiments, the flow rates may be different. Also, even though FIG. 2 illustrates that the inlets 210A and 210B may be supplied by the same flow regulator 212 and/or pump 206, each inlet may be provided with separate a flow regulator and/or a separate pump, in some embodiments.

As shown in FIG. 2, after entry into the air cap 204, the gas flow (208A and/or 208B) may assume a swirling flow 214 configuration which is subsequently exhausted through an exit hole 216 at the bottom of the air cap 204 in FIG. 2. In an embodiment, the air cap 204 may have a select shape (such as a substantially cylindrical shape) at least in portions that are in proximity to the flux tube 104, e.g., to cause the swirling flow 214. Furthermore, the inlets 210A and 210B may be provided in the same horizontal plane 217 (such as shown in FIG. 2, for example, where plane 217 is parallel to another plane that is lying along a top surface of the air cap 204) in an embodiment. Alternatively, the inlets 210A and 210B may be provided in different (e.g., parallel) horizontal planes in some embodiments. In an embodiment, the flux tube 104 may be equidistance from the perimeter of the air cap 204, e.g., in the center of the air cap 204. Also, the inlets 210A and 210B may be coupled to the air cap 204 on opposite sides of the flux tube.

In an embodiment, the flux tube 104 may include a flux nozzle 218 with one or more injection holes 220 to inject droplets (e.g., atomized droplets 110) towards the exit hole 216 for deposition onto the substrate 112. In one embodiment, the hole 220 may reduce the mean or average particle size in flux spray provided through the air cap exit hole 216. Furthermore, a prolonged contact of drops with the swirling coaxial flow 214 may reduce or eliminate the mean or average size of droplets 110.

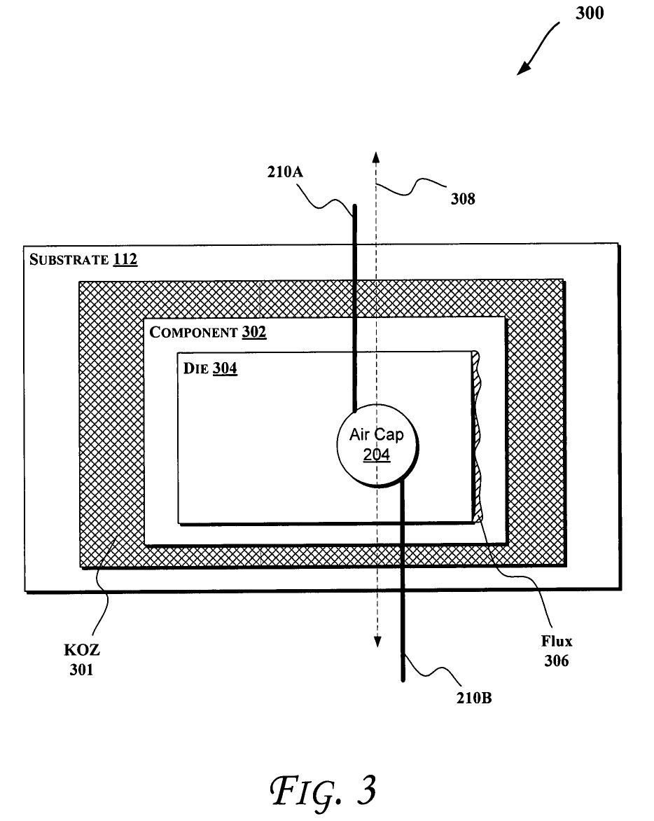

FIG. 3 illustrates a top view of a flux spray system 300 in accordance with an embodiment of the invention. In one embodiment, FIG. 3 may illustrate a top view of the system 200 of FIG. 2. As shown in FIG. 3, the system 300 may include the substrate 112 a portion of which may be designated as a keep out zone (KOZ) 301. In an embodiment, the KOZ 301 may designate an area where flux should be absent, e.g., to ensure a reduction or elimination of solder fines, high touch up rate and reliability issues, etc.

As illustrated in FIG. 3, a component 302 may be present on the substrate 112, e.g., within the KOZ 301. The component 302 may include an integrated circuit (IC) die thereon. Furthermore, the air cap 204 (e.g., including the inlets 210A and 210B) may be utilized to dispense flux fluid 102 (such as discussed with reference to FIG. 2) on the die 304. Some of the embodiments discussed herein may allow for a reduction in flux overspray or splash such that any additional flux may be maintained outside of the KOZ 301, such as shown in FIG. 3 with reference to flux 306. Even though flux 306 is shown on one side of the die 304, flux 306 may also be present on other sides of the die 304. In an embodiment, the inlets 210A and 210B may be provided at a tangential angle to the perimeter of the air cap 204 (e.g., as seen from a top side such as shown in FIG. 3). In some embodiments, even though FIG. 3 illustrates that both of the inlets 210A and 210B may be provided in a plane that is parallel to a vertical plane 308 (e.g., where plane 308 may be perpendicular to a plane that lies along a top surface of the die 304), the inlets 210A and 210B may be provided at an inclined angle to the plane 308 (e.g., at about 5 to 10 degrees relative to the plane 308). Additionally, the inclined angle of the inlets 210A and 210B relative to the plane 308 may not be equal in various embodiments. In one embodiment, the inlets 210A and 210B may be coupled to the air cap 204 in (vertical) planes that are parallel to each other while in other embodiments these planes may not be parallel to each other. In some embodiments, the inlets 210A and 210B may be equidistance from a plane 308 that intersects the center of the air cap 204.

Moreover, in some current implementations, having a single inlet for gas flow into the air cap 204 may result in overspray or flux droplets on or near the components side, which may further extend into the KOZ 301. This may cause solder fines, high touch up rate and reliability issues, spray paste related rework or touch-up, etc. Additionally, having a single inlet for gas flow into the air cap 204 may result in overspray or splash into the KOZ 301 that is more pronounced on a side of the die away from the entry of the single inlet (which may be referred to as an “air cap orientation effect”) Generally, air cap orientation effect may occur with air flow across a small path length (shorter residence times inside air-cap at air-velocities as high as about 150 m/s). Addressing these issues may be time consuming and may further add to the costs associated with manufacturing an electronic device. Hence, in some embodiments, a multi-entry tangential air inlet configuration (e.g., inlets 210A and 210B) and/or controlled air flow conditions (e.g., by utilizing one or more flow regulators 212), orientation effects of spray edge definition may be mitigated or eliminated. Moreover, in some embodiments, the air cap 204 of FIG. 2 may be used to: (a) control directional effect due to air turbulence; and (b) potentially effect canceling of opposing directional turbulence (e.g., generated by the flows 208A and 208B) while velocities as high as 150 m/s may be realized in the air cap 204.

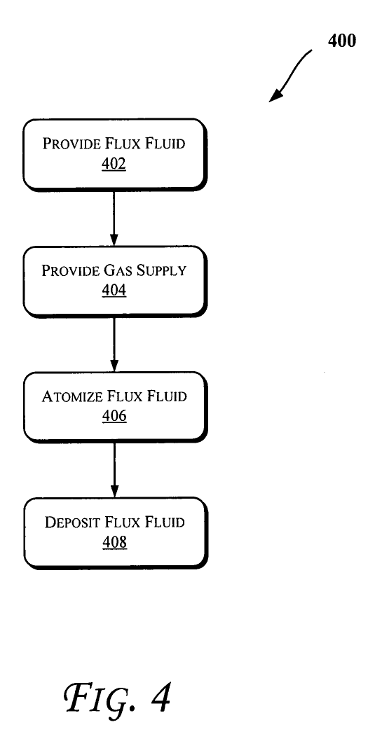

FIG. 4 illustrates a block diagram of an embodiment of a method 400 to improve flux spray splash control. In an embodiment, various components discussed with reference to FIGS. 1-3 may be utilized to perform one or more of the operations discussed with reference to FIG. 4. For example, the method 400 may be used to reduce flux overspray or splash (e.g., flux 306 of FIG. 3).

Referring to FIGS. 1-4, at an operation 302, flux fluid may be provided (e.g., by the flux supply 202). At an operation 404, gas may be supplied (e.g., via gas flows 208A and 208B). At an operation 406, flux fluid may be atomized, e.g., flux fluid 102 dispensed from the nozzle 218 into the flow 214 may be atomized. The atomized flux fluid may be deposited at an operation 408 (e.g., deposited onto the substrate 112).

In various embodiments of the invention, the operations discussed herein, e.g., with reference to FIGS. 1-4, may be implemented through hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device. For example, the operation of components of the system 200 of FIG. 2 may be controlled by such machine-readable medium.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
an air cap having a flux tube;
a first gas inlet coupled to the air cap on a first side of the air cap; and
a second gas inlet coupled to the air cap on a second side of the air cap,
wherein the first gas inlet and the second gas inlet are coupled to the air cap on opposite sides of the flux tube.

2. The apparatus of claim 1, wherein the first gas inlet and the second gas inlet are respectively coupled to the air cap in a first plane and a second plane, wherein the first plane and the second plane are parallel to each other.

3. The apparatus of claim 1, wherein the first gas inlet and the second gas inlet are coupled to the air cap in planes that are parallel to a plane that intersects a center of the air cap.

4. The apparatus of claim 1, wherein the first gas inlet and the second gas inlet are coupled to the air cap in planes that are equidistance from a plane that intersects a center of the air cap.

5. The apparatus of claim 1, wherein the first gas inlet and the second gas inlet are coupled to the air cap at a tangentional angle relative to a perimeter of the air cap.

6. The apparatus of claim 1, wherein the flux tube is equidistance from a perimeter of the air cap.

7. The apparatus of claim 1, wherein the first gas inlet and the second gas inlet are in a same horizontal plane.

8. The apparatus of claim 1, wherein the first gas inlet and the second gas inlet are in different horizontal planes.

9. The apparatus of claim 1, wherein the first gas inlet and the second gas inlet are provided at inclined angles relative to a first plane that is perpendicular to a second plane, wherein the second plane lies along a top surface of the air cap.

10. The apparatus of claim 1, further comprising a pump coupled to the air cap to provide a flow of an inert gas to one or more of the first gas inlet or the second gas inlet.

11. The apparatus of claim 10, wherein the inert gas comprises air, nitrogen, or mixtures thereof.

12. A method comprising:
providing a first flow of gas into an air cap; and
providing a second flow of gas into the air cap,
wherein the first flow and the second flow are applied from opposing directions to reduce turbulence inside the air cap.

13. The method of claim 12, further comprising coupling a first inlet for the first gas flow and a second inlet for the second gas flow to the air cap on opposite sides of air cap.

14. The method of claim 12, further comprising depositing flux fluid through an exit hole of an air cap onto a substrate.

15. The method of claim 12, further comprising pumping an inert gas into the air cap.
